(19) United States
(12) Patent Application Publication
(10) Pub. No.: US 2016/0229040 A1
(43) Pub. Date: Aug. 11, 2016

(54) WRENCH

(71) Applicants: Cheng-Pu Yang, Taichung (TW); Yu-Ting Hong, Taichung (TW); Chiou-Mai Chang, Taichung (TW)

(72) Inventors: Cheng-Pu Yang, Taichung (TW); Yu-Ting Hong, Taichung (TW); Chiou-Mai Chang, Taichung (TW)

(21) Appl. No.: 14/616,651

(22) Filed: Feb. 6, 2015

(51) Int. Cl. B25B 23/00

(52) U.S. Cl. CPC B25B 23/0028

(57) ABSTRACT

A wrench includes a first part having a first pivotal portion, a second part having a second pivotal portion, a connector pivotally connected in the first and second pivotal portions by two pins extending through the first and second pivotal portion and the two ends of the connector so as to pivotally connect the first part and the second part. Each of the first and second parts is pivotable relative to the connector.

### BACKGROUND OF THE INVENTION

1. Fields of the Invention

The present invention relates to a wrench, and more particularly, to a wrench having a first part and a second part, a connector is pivotably connected between the first and second parts, each of the first and second parts is pivotable relative to the connector.

2. Descriptions of Related Art

The conventional wrench generally comprises a head, a handle, a connector and two pins. The connector is connected between the head and the handle. One of the pins pivotably connects the rear end of the connector and the front end of the handle, and the other pin pivotably connects the rear end of the connector and the front end of the handle. The handle is pivotable relative to the head by the connector. However, when the two axes of the two pins are perpendicular to each other, the handle has to be pivoted to a dead point such that the head can be pivoted. This will lose the torque when operating the wrench. Furthermore, the pivotal actions of the handle and the head require a lot of space so that the wrench is not suitable for being used in a narrow space. Yet another problem is that the handle and the connector have to be made by the molding unit that has special specifications which increase the manufacturing cost.

The present invention intends to provide a wrench that eliminates the shortcomings mentioned above.

### SUMMARY OF THE INVENTION

The present invention relates to a wrench includes a first part, a second part, a connector and two pins. The first part has a U-shaped first pivotal portion, and the second part has a U-shaped second pivotal portion. The connector has two ends pivotally connected in the first and second pivotal portions by extending the two pins extending through the first and second pivotal portion and the two ends of the connector so as to pivotally connect the first part and the second part. Each of the first and second parts is pivotable relative to the connector. The first part and the second part do not interfere each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the wrench of the present invention;

FIG. 2 is a perspective view to show the first use status of the wrench of the present invention;

FIG. 3 is a perspective view to show the second use status of the wrench of the present invention;

FIG. 4 is a perspective view to show the third use status of the wrench of the present invention;

FIG. 5 is a perspective view to show the second embodiment of the wrench of the present invention;

FIG. 6 is a perspective view to show the use status of the wrench in FIG. 5 of the present invention;

FIG. 7 is a perspective view to show the third embodiment of the wrench of the present invention;

FIG. 8 is a perspective view to show the fourth embodiment of the wrench of the present invention, and

FIG. 9 is a perspective view to show the fifth embodiment of the wrench of the present invention.

### DETAILED DESCRIPTION OF THE PREFERRED EMBODIMENT

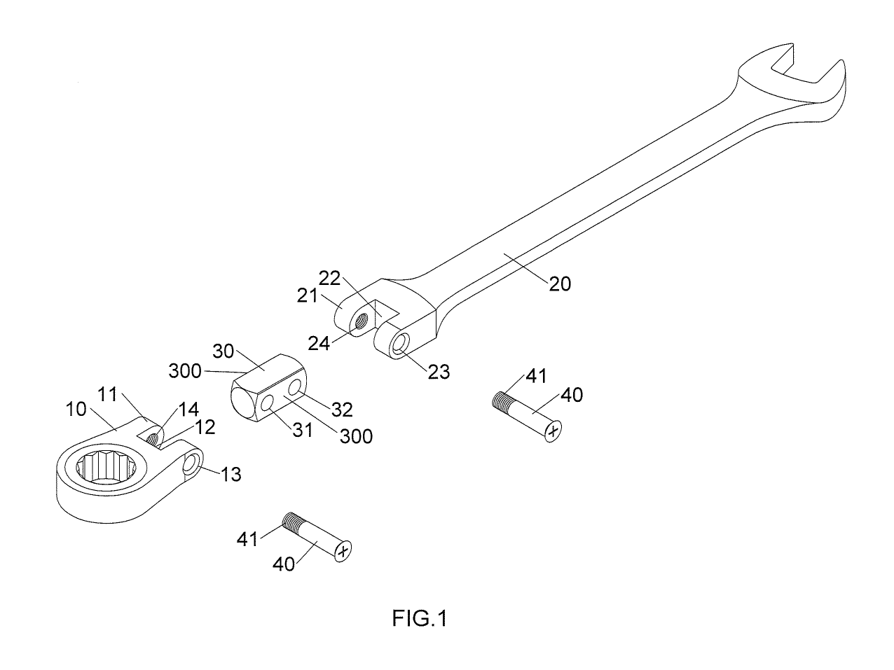

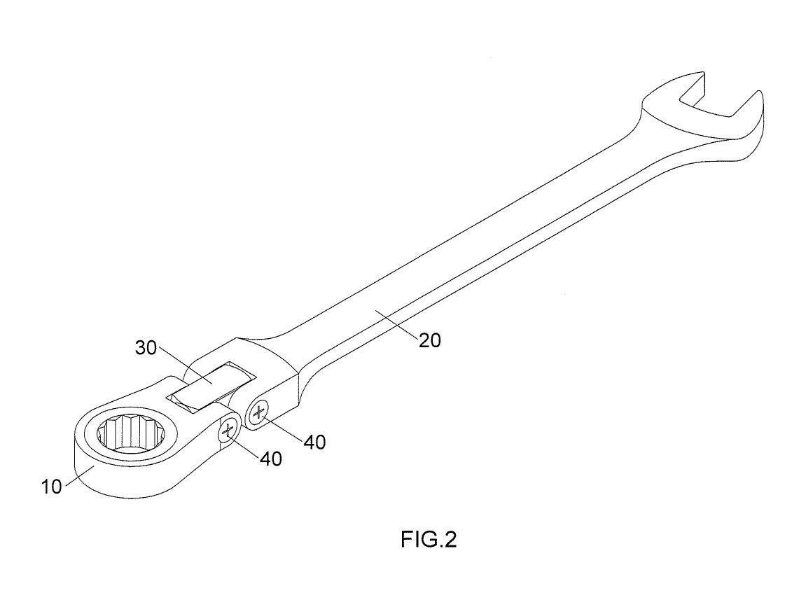

Referring to FIGS. 1 and 2, the wrench of the present invention comprises a first part 10, a second part 20 and a connector 30, wherein the first part 10 has a first pivotal portion 11 formed on the first end thereof. The first pivotal portion 11 is a U-shaped portion which has two extensions and a first recess 12 is defined between the two extensions. Each of the two extensions has a first hole 13, wherein one of the first holes 13 has a threaded portion 14 defined therein. The first part 10 has a function end formed on the second end thereof, in this embodiment, the function end is a box end and has a ratchet mechanism so as to drive ab object.

The second part 20 has a first end and a second end, wherein a second pivotal portion 21 is formed on the first end thereof and the second pivotal portion 21 is a U-shaped portion which has two extensions and a second recess 22 is defined between the two extensions of the second pivotal portion 21. The second recess 22 is located corresponding to the first recess 12. The width of the second recess 22 is equal to the width of the first recess 12. Each of the two extensions of the second pivotal portion 21 having a second hole 23 and one of the two second holes 23 has a second threaded portion 24 defined therein. The diameter of the second holes 23 is equal to the diameter of the first holes 13. The second part 20 has a grip portion and an open wrench head is formed on the second end thereof.

The connector 30 is a quadratic prism and has a first end and a second end, wherein the first end and the second end of the connector 30 are respectively located in the first recess 12 and the second recess 22. The connector 30 has two parallel engaging faces 300 located on two opposite sides thereof. The two engaging faces 300 each are in contact with insides of the first and second recesses 12, 22. A third hole 31 and a fourth hole 32 are respectively and transversely defined through the connector 30. The two respective axes of the third and fourth holes 31, 32 are parallel to each other. The distance between the third and fourth holes 31, 32 is sized so as to prevent the first part 10 from being in contact with the second part 20.

Two pins 40 each have a third threaded portion 41 on the distal end thereof. One of the two pins 40 extends through the first and third holes 13, 31, and the third threaded portion 41 is connected to the first threaded portion 14 of the first hole 13. The other one of the two pins 40 extends through the second and fourth holes 23, 32, the third threaded portion 41 is connected to the second threaded portion 24 of the second hole 23. By this way, the first and second parts 10, 20 are pivotably connected to each other by the connector 30.

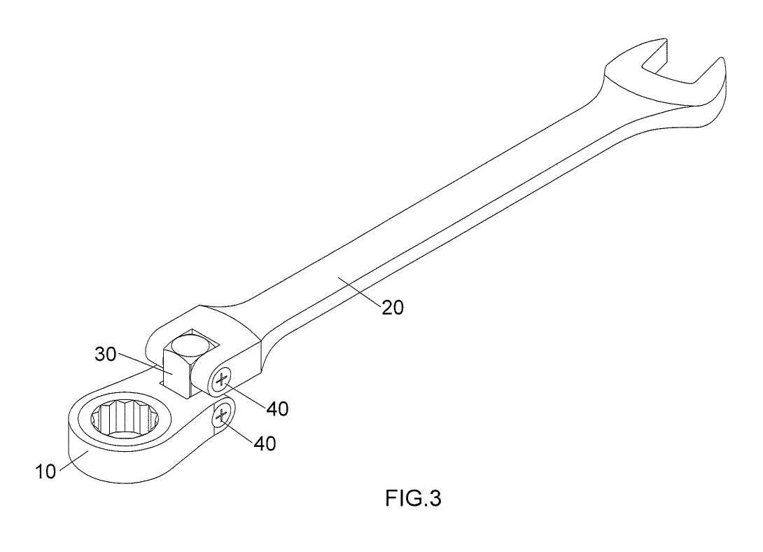

As shown in FIG. 3, the first part 10 is pivoted such that the connector 30 stands upright, a portion of the first part 10 is located beneath the second part 20. Because the two engaging faces 300 each are in contact with insides of the first and second recesses 12, 22, so that when rotating the second part 20, a sufficient torque is output to drive the first part 10.

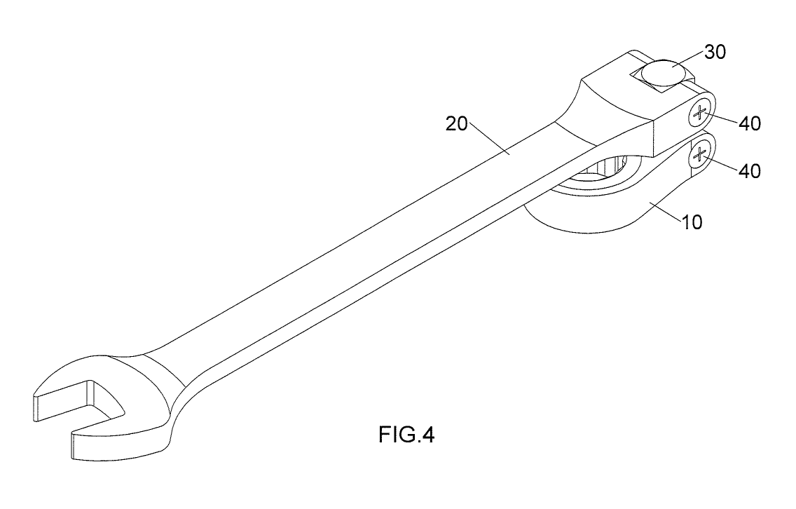

As shown in FIG. 4, the first part 10 is located beneath the second part 20 and a portion of the handle. When an object is engaged with the first part 10, the object contacts the underside of the second part 20, so that when rotating the second part 20 to drive the first part 10, the object is well position in the first part 10.

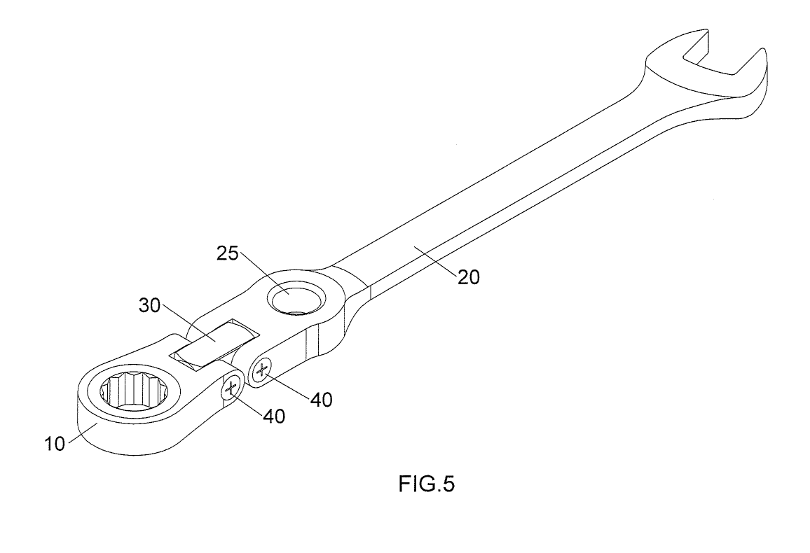

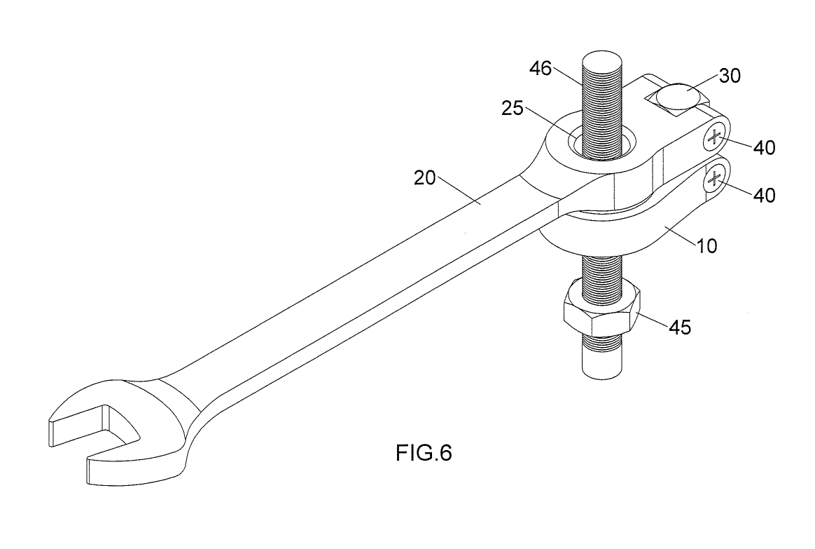

As shown in FIGS. 5 and 6, the second part 20 has a through hole 25, and the distance between the through hole 25 and the first end of the second part 20 is equal to the distance between the axis of the function end on the second end of the first part 10 and the first end of the first part 10. When the second part 20 is pivoted and overlapped on the first part 10, the through hole 25 of the second part 20 is in alignment with the function end of the first part 10. Therefore, a longer threaded rod 46 with a nut 45 can extends through the through hole 25 and the first part 10.

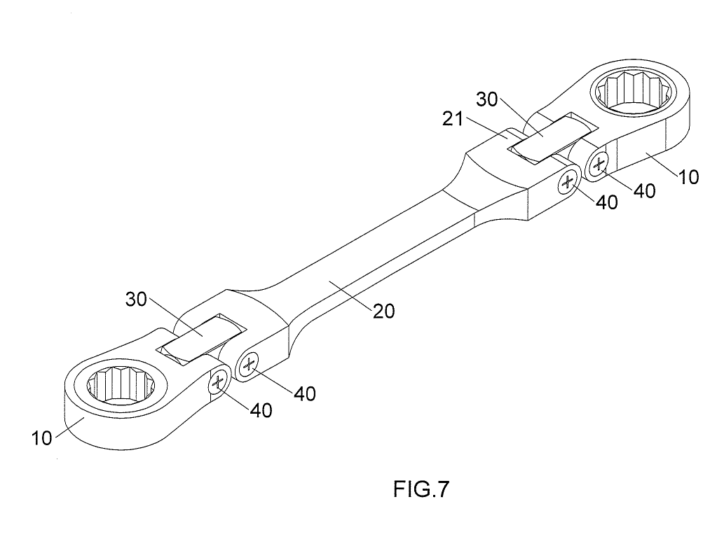

As shown in FIG. 7, the second part 20 has another second pivotal portions 21 formed on the second end thereof. There are two connectors 30 and two first parts 10. The two first parts 10 each have the first pivotal portion 11. The two first parts 10 are respectively and pivotably connected to the two second pivotal portions 21 of the second part 20 as shown. On each end of the second part 20, two pins 40 respectively extend through the second pivotal portion 21, the first pivotal portion 11 and the two respective connectors 30.

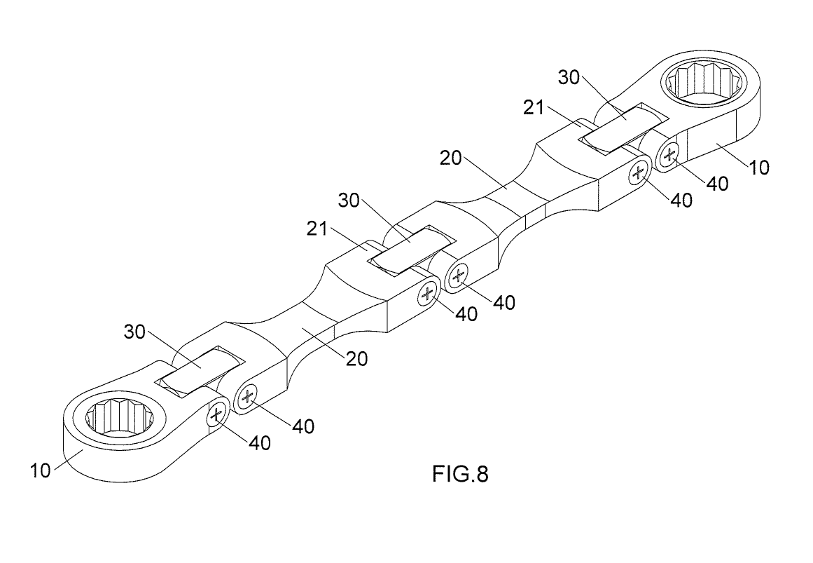

As shown in FIG. 8, there are two first parts 10 and each have the first pivotal portion 11. There are three connectors 30 and two second parts 20. The two second parts 20 each have one second pivotal portion 21 formed on each of the first and second ends thereof. The two second parts 20 are located along a straight line. One of the connectors 30 is pivotably connected between the two respective and adjacent second pivotal portions 21 of the two second parts 20. The two first parts 10 are respectively and pivotably connected to the two second pivotal portions 21 of the two second parts 20 by the two connectors 30.

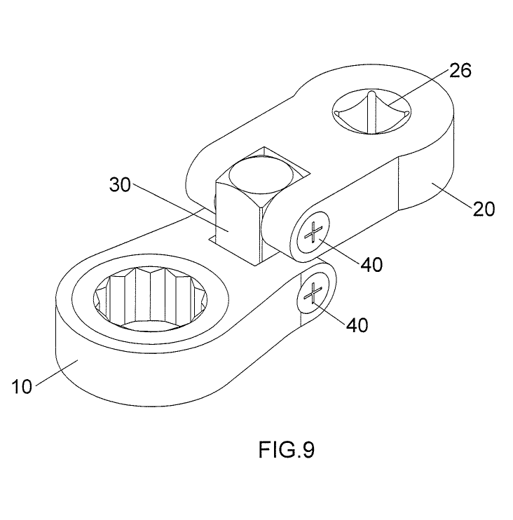

As shown in FIG. 9, the second part 20 has a rectangular hole 26 so as to be connected with a socket or another wrench with a rectangular protrusion.

It is noted that the pins 40 each are a rivet so that no threaded portion is needed. The connector 30 can be a cylindrical or hexagonal connector.

The wrench of the present invention provides a first part 10 and a second part 20 which does not interfere the pivotal action of the first part 10. The two ends of the connector 30 are respectively connected to the first part 10 and the second part 20, so that the first part 10 can be set at an angular position relative to the second part 20.

While we have shown and described the embodiment in accordance with the present invention, it should be clear to those skilled in the art that further embodiments may be made without departing from the scope of the present invention.

What is claimed is:

1. A wrench comprising:
at least one first part having a first pivotal portion formed on a first end thereof, the first pivotal portion being a U-shaped portion which has two extensions and a first recess located between the two extensions, each of the two extensions having a first hole, at least one the first part having a function end formed on a second end thereof;
at least one second part having a first end and a second end, a second pivotal portion formed on the first end of the at least one second part, the second pivotal portion being a U-shaped portion which has two extensions and a second recess located between the two extensions of the second pivotal portion, the second recess located corresponding to the first recess, a width of the second recess being equal to a width of the first recess, each of the two extensions of the second pivotal portion having a second hole, a diameter of the second holes being equal to a diameter of the first holes;
at least one connector being a quadratic prism and having a first end and a second end, the first end and the second end of the connector respectively located in the first recess and the second recess a third hole and a fourth hole respectively defined transversely through the connector, two respective axes of the third and fourth holes being parallel to each other, a distance between the third and fourth holes being sized that prevents the at least one first part from being in contact with the at least one second part, and
at least one two pins, one of the two pins extending through the first and third holes, the other one of the two pins extending through the second and fourth holes, the at least one first part and the at least one second part being pivotably connected to the at least one connector.

2. The wrench as claimed in claim 1, wherein the at least one second part has an open wrench head formed on the second end thereof.

3. The wrench as claimed in claim 1, wherein the at least one second part has a through hole, a distance between the through hole and the first end of the at least one second part is equal to a distance between an axis of the function end on the second end of the at least one first part and the first end of the at least one first part, the at least one second part is pivoted and overlapped on the at least one first part to align the through hole of the at least one second part with the function end of the at least one first part.

4. The wrench as claimed in claim 1, wherein the at least one second part has another second pivotal portions formed on the second end thereof, there are two connectors and two first parts, the two first parts each have the first pivotal portion, the two first parts are respectively and pivotably connected to the two second pivotal portions of the at least one second part by the two connectors and the four pins.

5. The wrench as claimed in claim 1, wherein there are two first parts and each have the first pivotal portion, there are three connectors and two second parts, the two second parts each have one second pivotal portion formed on each of the first and second ends thereof, the two second parts are located along a straight line, one of the connectors is pivotably connected between the two respective and adjacent second pivotal portions of the two second parts, the two first parts are respectively and pivotably connected to the two second pivotal portions of the two second parts.

6. The wrench as claimed in claim 1, wherein the at least two pins each are a rivet.

7. The wrench as claimed in claim 1, wherein the at least one connector has two parallel engaging faces located on two opposite sides thereof, the two engaging faces each are in contact with insides of the first and second recesses.
